(19) United States
(12) Patent Application Publication
(10) Pub. No.: US 2004/0137925 A1
(43) Pub. Date: Jul. 15, 2004

(54) Preselection of resources in a personal area network

(76) Inventors: Jason Lowe, Urbana, IL (US); Chung Sohn, Champaign, IL (US)

Correspondence Address: MOTOROLA, INC., 1303 EAST ALGONQUIN ROAD, IL01/3RD, SCHAUMBURG, IL, 60196

(21) Appl. No.: 10/339,094

(22) Filed: Jan. 9, 2003

(51) Int. Cl. H04Q 7/20; H04B 7/00

(52) U.S. Cl. 455/509; 455/563

(57) ABSTRACT

A method for preselecting resources in a personal area network includes providing (300) a plurality of communication devices with sharable resources on the personal area network. One of the communication devices is a radiotelephone used for preselecting (302) the resources for a particular personal area network configuration. These preselected resources are assigned (304) a named profile on the radiotelephone. A user can then select (306) the profile as a menu item or by a voice tag. The radiotelephone then automatically coordinates information transfer protocols (308) with the resources in the personal area network per the selected profile. The profile is used to quickly define and coordinate resources in a personal area network to suit a user's changing environment.

### FIELD OF THE INVENTION

The invention relates generally to methods and apparatus that provide communication over a wireless local area network (LAN), and more particularly to methods and apparatus that configures resources in the wireless LAN.

### BACKGROUND OF THE INVENTION

Wireless communication units, such as radiotelephones, personal digital assistants and other apparatus are now available to communicate over a local area networks (LAN). This can be accomplished utilizing the new Third Generation Partnership Project (3GPP) wireless cellular system or through the use short-range wireless transceivers to allow wireless communication with other local devices that are close to one another. For example, some appliances may include a local area network communication mechanisms, such as a Bluetooth™ based transceiver, short range optical transceiver, or other short range transceiver that allows communication via a local area network with other wireless devices, such as printers, headsets, etc. Generally, the wireless air interface between a wireless communication unit and cellular network and other local subscriber apparatus will be different. For example, common standardized cellular air interfaces include GSM, IS-95, IS-136 etc. Wireless LAN air interfaces include such things as Bluetooth™, IEEE 802.11, Hiperlan™, etc. The LAN ability has provided the opportunity for a user to form their own personal area network, consisting of devices or appliances having resources that can be shared among the devices on the LAN.

When implementing a personal area networks, a means of allocating resources for particular applications across the network of devices must be provided. For example, a means of routing voice and data to the proper resources spread across the network of distinct devices must be provided. Resource management of multiple, distinct devices already exists for the fixed end phone and cellular networks. For example, trunked radio systems are able to determine what fixed resources are available to them. These resources can include, for example, what channels are available what consoles are available, what security modules are available, etc. However, this fixed resource management has not been done on small, personal devices using wireless technologies, and cannot account for portable wireless dynamics where the particular devices in a network can change depending on the movement of the user.

Another approach to resource management is the Bluetooth™ service discovery technique, wherein one device must query other devices for available resources. However, in this technique, the resources in the Bluetooth network are unknown unless a device is queried about its resources. Further, it is often not obvious how a user's information streams (audio, video, data, etc.) should be routed among various personal area network devices. For example, a user may wish for the cellular phone to display the video for a visual phone call through the nearby, television while routing the audio through a home audio system. Such a configuration has been difficult to configure completely automatically, as the mere proximity of the audio system and television is not sufficient evidence that the user wishes to use those device resources. As another example, a user who walks through one room to another room while talking on a cellular phone may not want the audio and TV system to take over the phone call. In other words, the user is just passing through the room, not entering the room to use the audio and TV systems for the call. Therefore, the user is required to set the configuration manually, often by choosing a number of menu options to route the video, audio, etc. If this is a common scenario for the user, the manual configuration of a personal area network can quickly become tedious.

In addition, personal area networks tend to be very ad-hoc with different devices available for each user or perhaps for each connection. A solution must be able to address a more random availability of devices than fixed end networks. For example, a user should be able to simplify the reconfiguration of a personal area network as needed.

Accordingly, a need exists for a technique for a user to easily reconfigure their dynamic personal area network (PAN). It would also be advantageous, if the devices in the PAN could communicate autonomously, once the resource configuration has been set. In other words, communication in the personal area network should be able to be managed by the wireless devices themselves, without the intervention of the device that sets the configuration (e.g. cellular phone).

### BRIEF DESCRIPTION OF THE DRAWINGS

The features of the present invention which are believed to be novel are set forth with particularity in the appended claims. The invention, together with further objects and advantages, may best be understood by reference to the following description taken in conjunction with the accompanying drawings, in the several figures of which reference numerals identify like elements, in which:

FIG. 1 is a block diagram illustrating an example of a personal area network, in accordance with the present invention;

FIGS. 2-5 are graphical illustrations of a setup menu to preselect resource for a personal area network, in accordance with the present invention; and

FIG. 6 is a flow chart illustrating a method for preselecting resources for a personal area network, in accordance with the present invention.

### DETAILED DESCRIPTION OF A PREFERRED EMBODIMENT OF THE INVENTION

The present invention provides a technique for a user to easily reconfigure their dynamic personal area network (PAN) by using a pre-stored configuration of resources that can be recalled using a voice tag or a menu key. The present invention provides the ability to associate the configuration of a personal area network with a menu key or voice tag. Once a user has manually setup a personal area network configuration through the normal process, the personal area network configuration can be stored as a profile and quickly recalled by associating the configuration with a voice tag or menu key in the phone. The user can then quickly activate a particular personal area network configuration by saying the corresponding voice tag or selecting the appropriate menu key. The resulting personal area network configuration may or may not involve the setup device (i.e. cellular phone). In the latter case, the phone acts merely as a device used to transmit the configuration information to the devices participating in the personal area network.

With this capability, the user can quickly and easily select commonly used personal area network configurations. Personal area network configuration becomes greatly simplified, especially when many devices are involved for a particular personal area network scenario. Using the previous audio/television phone call example, the user could manually setup a personal area network configuration for a video call with the audio and video routed through the home theater system. The user could then associate this personal area network configuration with a menu key of voice tag such as “Home Video Call”. Whenever the user wishes to activate that particular personal area network configuration, the user simply selects the menu shortcut or speaks the voice tag, thereby avoiding a manual personal area network setup.

Assuming there are no resource conflicts in the system, applications can select the resources in the personal area network as needed, using different resources. For example, FM Stereo and UMTS Data Call could occur simultaneously within the personal area network. However, it is envisioned the resource conflicts or redundancies could arise in the personal area network. Therefore, in a preferred embodiment, each profile will also register certain preference attributes for the available resource. The preference attribute is used when assigning resources for each application. For example, a Bluetooth headset may have the preference set for the audio resource, so that anytime the Bluetooth headset is available in the personal area network, the profile will use it for all connections with an audio resource. These preference attributes can be entered when the user set up the profile, or can be determined dynamically among the distinct devices in the personal area network.

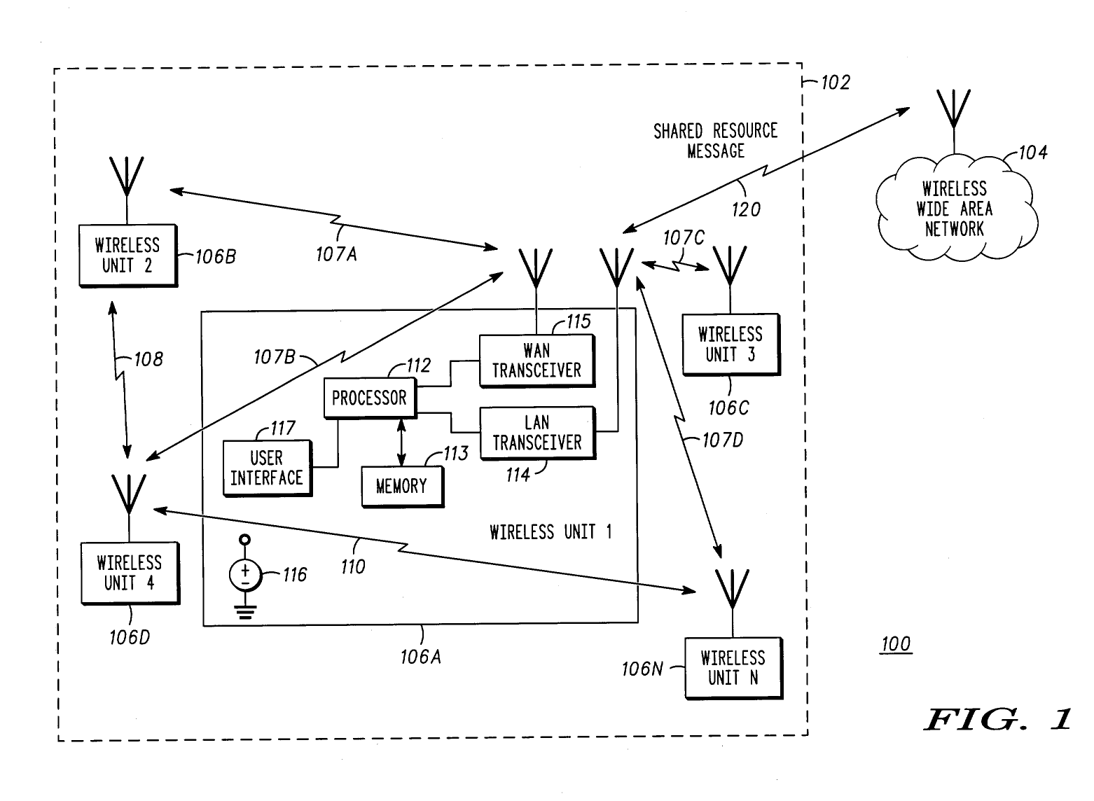

FIG. 1 is a block diagram illustrating a personal area network 100, in accordance with the present invention, that includes a wireless local area network (LAN) communication system 102, such as a short range wireless communication system compliant, for example, with the Bluetooth™ standard, or any other suitable short range communication protocol including, but not limited to, 802.11 or optical communication protocols. Optionally, the personal area network 100 can include a connection to a wireless wide area network (WAN) communication system 104, such as any one of the available cellular communication systems such as a CDMA or GSM communication system, a wireless link to the Internet, or any other suitable communication system. The wireless local area network communication system 102 portion of the personal area network includes a plurality of wireless communication devices 106a-106n operable thereon, such as a radiotelephone device, including, but not limited to, hand held apparatus, laptop computers, desk top computers, or any other suitable wireless communication device, and various wireless peripherals such as a printer, fax, headset, speakerphone, or any other device with a LAN transceiver.

Each of the wireless units 106a-106n has resources sharable with the personal area network and includes a wireless local area network communication transceiver, such as a Bluetooth™-based transceiver, and can include a wireless wide area network transceiver, such as a CDMA cellular transceiver. Each of the wireless units can communicate in a peer-to-peer arrangement with each other using the wireless local area network communication transceivers, and those with a wireless wide area network transceiver can communicates individually with the wireless wide area network communication system 104. As illustrated, wireless units 106b-106n are operative to communicate using a wireless local area network protocol with wireless unit 106a via wireless LAN communication links 107a-107d. Wireless unit 106b and wireless unit 106d are in close enough proximity to allow communication between these two apparatus as shown by communication link 108. Similarly, wireless unit 106d and wireless unit 106n are also in close enough proximity to allow wireless local area network communication as illustrated by communication link 110. However, as shown, wireless unit 106c may not be within an acceptable proximity with wireless unit 106n to allow short-range communication between these two apparatus. Optionally, wireless unit 106a is in communication with the wireless wide area network 104 via link 120.

In this embodiment, each of the wireless units 106a-106n includes (as only shown in unit 106a for simplicity) a processor 112, such as a digital signal processor, microprocessor, discrete logic or any other suitable circuitry that can execute applications. For example, the processor 112 executes instructions that are stored in memory 113 that cause the processor 112 to, among other things, determine whether the resources of the wireless apparatus 106a are available to share with the wireless personal area network. The processor 112 can also determine an operational status of the unit. All of this information, is transferred through the LAN transceiver 114 (and/or optionally the WAN transceiver 115) to a resource manager (in this case unit 106a) of the personal area network 100. Typically, the processor 112 of each unit is operatively coupled to a suitable user interface 117, in accordance with the particular operation of the unit, such as audio, visual, haptic, text, mechanical, and other user interface devices. In particular, these interface devices can be a display screen, keypad, speaker, microphone, voice recognition apparatus, or any other input apparatus associated with the particular resource of the unit.

In operation, once the profile has been selected the personal area network operates automatically, without user intervention, to provide optimal resource management. This automatic operation generally entails the resource manager of the network periodically looking for, and registering, one or more available resources defined by the profile. The resource manager keeps a table of available resources in its memory for use by the personal area network for the selected profile, as needed. For example, if the profile “Home Video Call” is selected, and this profile calls for the use of a user's television for video, and the user's stereo system for audio, the resource manager will continually look for the television or stereo in the personal area network. If these particular resources are unavailable or become unavailable due to the user moving through the house, the profile will designate the next priority devices for video or audio. Similarly, if the user moves through the house such that the television and stereo are regained in the personal area network, the resource manager can register these devices on the personal area network and use them for video and audio, respectively. This is all accomplished autonomously. However, in some cases there may be a need for user intervention in the resource management of the personal area network. For example, if an application running on any unit of the personal area network requires a particular resource of some other unit, or there are found two units with the same available resource and having the same priority, or if there are no units with the needed resource, then a user can be asked to intervene to decide the proper course of action.

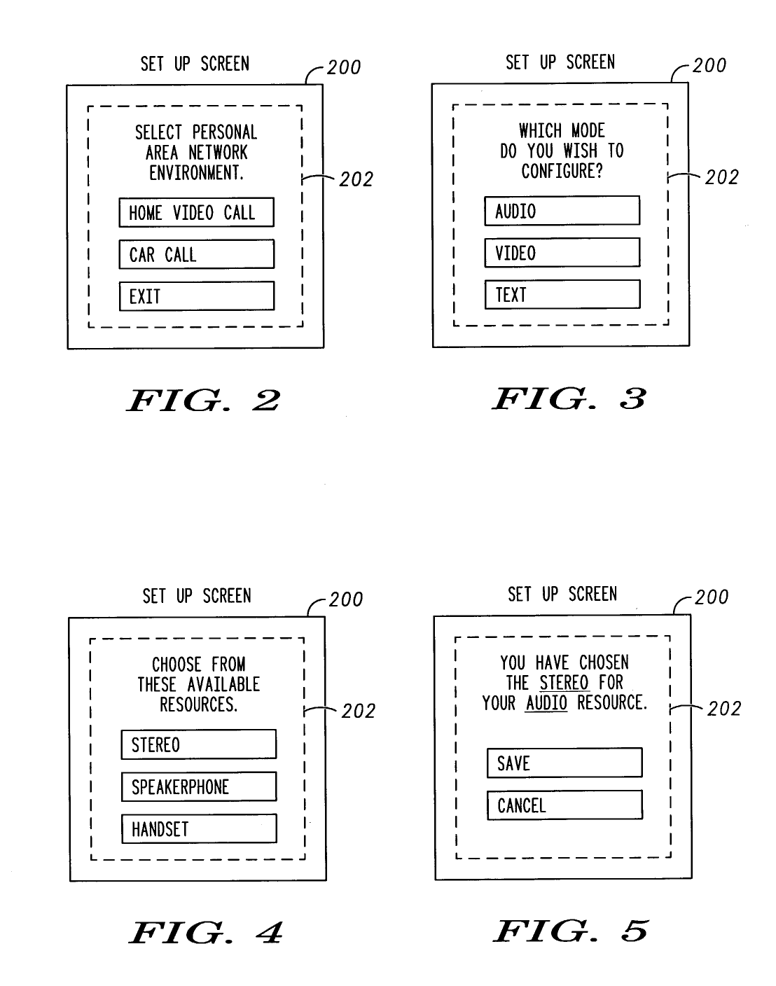

Referring to FIGS. 1 and 2, the present invention provides for preselecting the resources for a particular personal area network configuration. In particular, processor 112 of the resource manager is coupled to a display apparatus of a user interface 117 to allow the processor to provide a set up screen 200 to preselect any particular resource under a chosen profile name. The set up screen 200 of the user input interface 117 having a selection menu 202 to generate a message that a user can use to select or prioritize the shared wireless personal area network resources. In this example, a set up screen 200 is provided which includes the query, “Select personal are network environment”. There are two profiles shown here, “home video call” and “car call” as an example. However, it should be realized that name profiles can be used, with standard or customized names. Each profile is assigning on the radiotelephone to a set of associated preselected resources. In this example, the user of the radiotelephone can select the “home video call” profile button, which then generates a signal to the processor 112 indicating the profile selected.

Referring to FIG. 3, the processor then has the set up screen 200 display a menu 202 of the modes that are available for the resource manager to use in the personal area network. Typically, this is preset depending on the multimedia capabilities of the resource manager. In this example, a radiotelephone handset is configures for audio information, text information, and video information. Therefore, the processor has the set up screen display the query “Which mode do you wish to configure?” The user would then select the mode to configure, such as “audio”.

Referring to FIG. 4, the processor then determines the resources available in the personal area network, and displays these on the set up screen 200. Optionally, the user can pre-enter the resources that the user would prefer to use in the personal area network, if available. In this example, the menu shows resources of “stereo”, “speakerphone”, and “handset”. The processor has the set up screen display the query “Choose from these available resources.” The user would then select one or more of the available resources, such as “stereo”, for example.

Referring to FIG. 5, the processor confirms with the user the resources chosen for the selected mode. For example, the processor has the set up screen 200 display the statement “You have chosen the stereo for the audio resource”, and the menu 202 provides a selection for the user to cancel this choice or save it into the originally selected profile. The processor can then preset an acknowledgement on the set up screen or return to the screen of FIG. 2, where the user can choose to continue with preselection or exit the profile configuration. Preferably, this same screen set up can be use to prioritize resources when they are preselected.

Once a profile has been set up, and is subsequently selected by a user for their personal area network, the resource manager coordinates information transfer protocols with the resources in the personal area network in accordance with the preselected profile on the radiotelephone. The resource manager can then let the personal area network operate autonomously, or it can join in the personal area network. Specifically, and referring back to FIG. 1, the processor 112 generates a message (such as link 107a to wireless unit 106b for example) indicating that the wireless apparatus 106b will allow shared use of its resources by an application running on the personal area network.

The memory 113 is operatively coupled to processor 112 and includes executable instructions that when executed by the processor 112 causes the processor 112 to, among other things, direct the indicated unit to respond to the application I/O instruction either directly from the requesting device or relayed through the resource manager. It should be recognized, however, that instead of the processor 112 executing instructions, any suitable hardware, combination of hardware, software and firmware could be utilized as desired. Accordingly, the processor 112 may control other circuits or processing devices to perform the operations set forth herein.

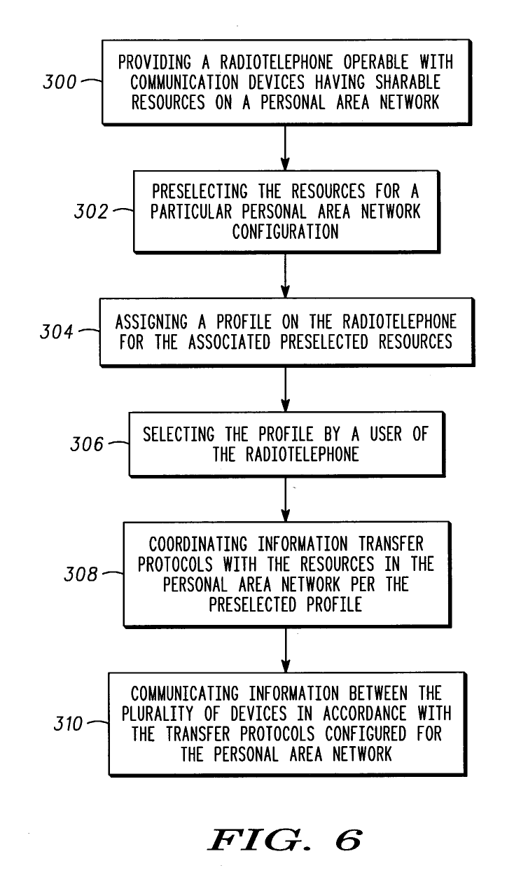

FIG. 6 is a flow chart illustrating a method for preselecting resources in a personal area network, in accordance with the present invention. The resources are selected per a user environment. For example, a user environment can be a home, car, office, etc. The personal area network is operable on one or more of a wireless local area network (LAN)) and a wireless wide area network (WAN). The method includes a first step 300 of providing a plurality of communication devices, including a radiotelephone, operable on the personal area network. Each communication device has resources sharable with the personal area network. A resource manager, such as a set of executable instructions on the radiotelephone, is able to communicate and manage the available resources of its resident device on the personal area network. Optionally, this step includes at least one of the communication devices without a user interface, with the radiotelephone serving as a user interface proxy for the at least one communication device. A next step 302 includes preselecting the resources for a particular personal area network profile, as was done in accordance with the explanation and description for FIGS. 2-5.

A next step 304 includes assigning and storing a profile on the radiotelephone for the associated preselected resources, as was done in accordance with the explanation and description for FIGS. 2 and 5. Specifically, a named menu item on the radiotelephone is assigned to an associated profile. This named menu item can be a text name or a voice tag stored in the radiotelephone. A next step 306 includes selecting the profile by a user of the radiotelephone. Specifically, a named menu item on the radiotelephone is selected by a key press on a keyboard, menu selection on a display, or by speaking a voice tag into the radiotelephone. Selecting can occur anytime, and can occur before or after initialization and registration of the personal area network. Both of these steps are accomplished through the user of a user interface, as explained previously. The processor, for example, can set up a user interface with a selection menu to allow selection and/or prioritization of resources available to the personal area network. Without preselection by a user, the resource manager can automatically select resources based on what resources are available, predetermined priorities or a selection algorithm.

A next step 308 includes coordinating information transfer protocols with the resources in the personal area network in accordance with the preselected profile on the radiotelephone. This step can include periodically checking for changes in the availability of resources. For example, coordination can be through the resource manager, or can be directly between devices once the resource manager establishes peer-to-peer resource protocols for an application. Given any change of status of a resource, loss of power, conflict, new application, etc., the resource manager can automatically re-route information to adapt to changes in the availability of resources. In this way, the resource manager of the network can update its resource table properly. To provide improved operation, this step can include registering a preference attribute of each device or resource. Preference attributes can provide an initial priority of a resource to automatically resolve conflicts if other similar resources are available. Preferences can also be established between complimentary resources, such as a preferred earpiece to be used with a corresponding microphone. The resource manager can take the preference attributes of a device into account when coordinating information transfer among available resources.

As next step 310 includes communicating information between the plurality of devices in accordance with the transfer protocols configured for the personal area network in the coordinating step. Typically, communication begins upon initiation of an application on the personal area network. Such application, running on any of the devices, would request resources from the resource manager. It is envisioned that a requesting application would originate on the device of the resource manager. However, any of the devices on the personal area network can originate an application. In such case, the resource manager of the particular device running the application requests, through the resource manager, the necessary resources. The communicating of information can occur with the radiotelephone (resource manager) connected or disconnected from the personal area network. It is also envisioned that, on occasion, there will be more than one application running on a personal area network. In this instance, there can arise conflicting demands for resources. Therefore, it is preferred that this step includes allocating application priorities such that a new application can preempt resources from another application in accordance with the priority associated with the new application.

It will be recognized that the local area network communication in the present invention can be an optical local area network as well as a radio frequency-based local area network or any other suitable or any other suitable wireless LAN. In this example, the wireless local area network can be any suitable short-range local area network as desired.

It is also understood that the wide area and local area communication to the individual communication devices might not be from the same networks. For example, one system may be a UMTS system to access particular data, while another system may utilize a GSM system. Similarly, different LAN systems can be utilized. It should be recognized that protocols can be in place to allow the desired connection between a communication device, a LAN, and a WAN, even if the subscriber does not have the capability to access a particular network.

As described herein, and as previously noted, each of the wireless communication devices can include a wireless wide area network transceiver and a wireless local area network transceiver along with a processing device that is operatively coupled to the wireless wide area network transceiver and to the wireless local area network transceivers wherein the processing device is operative to perform the above-identified operations. Accordingly, the processing devices may be programmed with executable instructions or applications that, when executed, cause the processing device or devices to perform the operations described herein.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the broad scope of the basic underlying principles disclosed and claimed herein.

What is claimed is:

1. A method for preselecting resources in a personal area network, the method comprising the steps of:
providing a plurality of communication devices including a radiotelephone operable on the personal area network, each communication device having resources sharable with the personal area network;
preselecting the resources for a particular personal area network configuration;
assigning a profile on the radiotelephone for the associated preselected resources;
selecting the profile by a user of the radiotelephone; and
coordinating information transfer protocols with the resources in the personal area network in accordance with the preselected profile on the radiotelephone.

2. The method of claim 1, wherein the resources of the preselecting step are selected per a user environment.

3. The method of claim 1, wherein the assigning step includes assigning a named menu item on the radiotelephone to the associated profile, and the selecting step includes selecting the named menu item on the radiotelephone.

4. The method of claim 1, wherein the assigning step includes assigning a specific voice tag on the radiotelephone to the associated profile, and the selecting step includes speaking the voice tag into the radiotelephone.

5. The method of claim 1, further comprising the step of communicating information between the plurality of devices in accordance with the transfer protocols configured for the personal area network in the coordinating step.

6. The method of claim 5, wherein the communicating of information occurs with the radiotelephone disconnected from the personal area network.

7. The method of claim 1, wherein the providing step includes at least one of the communication devices without a user interface, the radiotelephone serving as a user interface proxy for the at least one communication device.

8. A method for preselecting resources in a personal area network, the method comprising the steps of:
providing a plurality of communication devices including a radiotelephone operable on the personal area network, each communication device having resources sharable with the personal area network;
preselecting the resources for a personal area network configuration operable for a particular user environment;
assigning a profile on the radiotelephone for the associated preselected resources;
selecting the profile by a user of the radiotelephone;
coordinating information transfer protocols with the resources in the personal area network in accordance with the preselected profile on the radiotelephone; and
communicating information between the plurality of devices in accordance with the transfer protocols.

9. The method of claim 8, wherein the assigning step includes assigning a named menu item on the radiotelephone to the associated profile, and the selecting step includes selecting the named menu item on the radiotelephone.

10. The method of claim 8, wherein the assigning step includes assigning a specific voice tag on the radiotelephone to the associated profile, and the selecting step includes speaking the voice tag into the radiotelephone.

11. The method of claim 8, wherein before the communicating step further comprising the step of disconnecting the radiotelephone from the personal area network.

12. The method of claim 8, wherein the providing step includes at least one of the communication devices without a user interface, the radiotelephone serving as a user interface proxy for the at least one communication device.

13. A system for preselecting resources in a personal area network, the system comprising:
a plurality of communication devices operable to communicate together in the personal area network, each communication device having resources sharable with the plurality of communication devices in the personal area network;
a radiotelephone operable on the personal area network, the radiotelephone having storable profiles for particular associated configurations of the resources in the personal area network defined by an environment of the user of the radiotelephone, the resources of the personal area network can be preselected and assigned under a named profile that can be later selected by the user upon entering the associated environment, wherein the radiotelephone coordinates information transfer protocols with the resources in the personal area network in accordance with the selected profile; and
an application that requests resources on the personal area network from the radiotelephone, which subsequently allocates the necessary resources in accordance with the selected profile.

14. The system of claim 13, wherein the radiotelephone includes a display with a listed menu item for selected the profile associated the preselected resources.

15. The system of claim 13, wherein the radiotelephone includes a microphone, processor and memory for storing voice tags associated with the profile, wherein a user reciting the associated profile into the microphone causes the processor of the radiotelephone to automatically coordinate the information transfer protocols with the resources in the personal area network in accordance with the selected profile.

16. The system of claim 13, wherein the radiotelephone can disconnect itself from the personal area network once the information transfer protocols of the personal area network are established and communication with the radiotelephone is no longer needed, leaving the devices on the personal area network to communicate among themselves.

17. The system of claim 13, wherein the radiotelephone can serve as a user interface proxy for any communication device not having a user interface of its own.
